(19) United States
(12) Patent Application Publication
(10) Pub. No.: US 2006/0090382 A1
(43) Pub. Date: May 4, 2006

(54) Decorative memory scrolls

(76) Inventor: Linda Stilley, Tulsa, OK (US)

Correspondence Address: Starkweather and Associates, Suite 200, 9035 South 1300 East, Sandy, UT, 84094, US

(21) Appl. No.: 10/978,030

(22) Filed: Oct. 28, 2004

(51) Int. Cl. G09F 11/18

(52) U.S. Cl. 40/514

(57) ABSTRACT

A decorative memory scroll that includes a frame, a writing sheet attached to the frame, and a decorative section attached to the writing sheet configured to wrap around the writing sheet when the writing sheet is wrapped around the frame to provide a decorative appearance thereto. The decorative section may attach to a back side of the writing sheet or to a distal end of the writing sheet. The decorative scroll may include at least one handle attached to the frame and a securing device configured to secure the decorative section in a wrapped position about the frame, which may be a cord, button, clasp, or clip. In another embodiment, the frame is hollow and configured to hold items and includes a removable handle coupled to the frame. The handle may be a door knob, a helmet configured to represent a particular sport team and the handle may screw on friction fit, or bayonet fit the frame. A base allows for vertical orientation of the scroll. A pair of wings, or other decorative material, may be attached to the decorative section for an additional decorative appearance.

### BACKGROUND OF THE INVENTION

1. The Field of the Invention

The invention relates to scrolls. More particularly, the present invention relates to decorative scrolls for holding information and objects of past memories.

2. The Relevant Art

Scrolls were something that ancient people used as books. In those days, prayers, prophecies, documentation, stories, and even paintings were created on rolls of papyrus or parchment papers. The scrolls served as a recorded history.

The great libraries of ancient Egypt, Greece, and Rome consisted of collections of papyrus scrolls. But these libraries disappeared, and most of what we know about them is based on second-hand reports. For example, scholars have found references to Egyptian libraries at Amarna in the 1300's B.C. and at Thebes in the 1200's B.C. However, these ancient libraries of papyrus have disappeared.

The most famous library of ancient times was the Alexandrian Library in Alexandria, Egypt. The Alexandrian Library had a copy of more than 400,000 scrolls, basically every existing scroll known to the library's administrators. Not a trace of the Alexandrian Library remains today and no one knows for certain what became of it.

The scrolls generally comprised one or two rods made of wood, ivory or bronze. The scrolls were then later placed into jars. Centuries later, the interest in scrolls, their appearance, their mystique, and their symbolism continue to intrigue many of us. Accordingly, scrolls are still seen in many aspects of our lives.

Today, handwritten messages are rare and therefore much more personal and precious. Modern scrolls may be used to mark all kinds of life milestones such as a goddaughter's wedding, the birth of a grandchild, a friend's promotion, a memorial to a veteran grandfather, significant birthdays, and to express sympathy for the loss of a loved one. The scroll becomes a treasured item that the recipient will keep and will allow them to enjoy their friends' and family's handwritten, heartfelt messages for years.

The following patents and applications are hereby incorporated by reference for their teachings.

U.S. Pat. No. 6,684,541 to McPhaul describes a prayer scroll for creating and retaining writings such as prayers. A replaceable paper webbing is retained on, and in use unwound from, a rotary spool within a hollow housing. To rewind the paper webbing onto the spool, a locking wheel is unlocked by use of a button. A retraction spring and comfort spring balance the return force of the paper webbing. A pen may be stored within the article for writing purposes in use. A key activates a locking device to prevent unwanted release of the paper webbing.

U.S. Pat. No. 6,609,318 to Augustine et al. describes a scroll-type display device. The display device is adaptable to use a cartridge of flexible material terminating at each end in a tubular element (scroll). The display device comprises a pair of spool-rod means, each one of the pair of spool-rod means including rod means, first handle means axially connected at one end of the rod means, and second handle means outwardly extending at the other end of the rod means. The rod and first handle means are provided with attaching means for detachably connecting the rod and first handle means. The display device exposes text and/or images to be viewed as consecutive incremental portions of the flexible material, which is adapted to be rolled or unrolled.

U.S. Pat. No. 5,605,001 to Derk describes an ornamental scroll device comprising a flexible sheet including two opposed outer end portions, two opposed outer edges, and an indicia bearing section having a message located on an obverse side of the flexible sheet and between the end portions and outer edges. A stiffening member maintains the indicia bearing section rigid between the outer end portions. Each of the outer end portions includes a roll section having two end caps secured at opposite ends of each roll section. A hanging or folding member is used for displaying the indicia bearing section.

U.S. Pat. No. 4,64,453 to Reinhart describes a scroll type calendar display device. A web backing support interconnecting tubular housings in spaced relation, extends through slots formed in extensions of closure caps coaxially mounted on the ends of the tubular housings to render the caps non-rotatable. Adjusting knobs axially fixed to scroll shafts rotationally supported by the end caps, within the tubular housings, are engaged by the end caps under spring bias to resist rotation of the scroll shafts and thereby yieldably hold the web in adjusted positions.

U.S. Application Number 2004/0064986 to Anderson describes a wall-integrated roll-up decoration for concealing objects. A frame surrounds a framed area. The frame has an interior side and an exterior side opposite the interior side. An object to be displayed at certain times, such as a television set, is placed within the framed area. A flexible canvas cover has an area that is greater than or equal to the framed area. A storage roll is secured to the flexible canvas cover, thereby allowing the flexible canvas cover to be rolled onto the storage roll. A roll driver mechanism is securably attached to the interior side of the frame. The roll driver mechanism rotates the storage roll, thereby moving the flexible canvas cover between a deployed position and a retracted position. In the deployed position, the flexible canvas cover covers the framed area; in the retracted position, the flexible canvas cover is rolled onto the storage roll, and is positioned adjacent to the interior side of the frame.

The scrolls referenced above fail to take full advantage of both the aesthetic possibilities of scrolls as well as the symbolism that the scrolls represent. Thus, it can be clearly recognized that there is a need for a decorative memory scroll that overcomes the disadvantages of the prior art.

### SUMMARY OF THE INVENTION

The various elements of the present invention have been developed in response to the present state of the art, and in particular, in response to the problems and needs in the art that have not yet been fully solved by currently available scrolls. Accordingly, the present invention provides a decorative memory scroll that improves, or overcomes existing scrolls.

More particularly, according to one embodiment, the decorative scroll includes a frame, a writing sheet attached to the frame, and a decorative section attached to the writing sheet configured to wrap around the writing sheet when the writing sheet is wrapped around the frame to provide a decorative appearance thereto. The decorative section may attach to a back side of the writing sheet or to a distal end of the writing sheet.

The decorative scroll may include at least one handle attached to the frame and a securing apparatus configured to secure the decorative section in a wrapped position about the frame, which may be a cord, button, clasp, or clip.

In another embodiment, the frame is hollow and configured to hold items and includes a removable handle coupled to the frame. The handle may be a door knob, a helmet configured to represent a particular sport team and the handle may screw on friction fit, or bayonet fit the frame.

In yet another embodiment, a base is attached to the frame and configured to allow for vertical orientation of the scroll. A pair of wings, or other decorative material, may be attached to the decorative section for an additional decorative appearance.

Additional features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a side view of an unwrapped decorative scroll according to one embodiment of the present invention;

FIG. 2 illustrates a side view of a decorative scroll according to one embodiment of the present invention;

FIG. 3 illustrates a manner in which writing sheets may be attached to a frame of the decorative scroll according to one embodiment of the present invention; and

FIG. 4 illustrates a side cross-sectional view of the decorative scroll according to one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

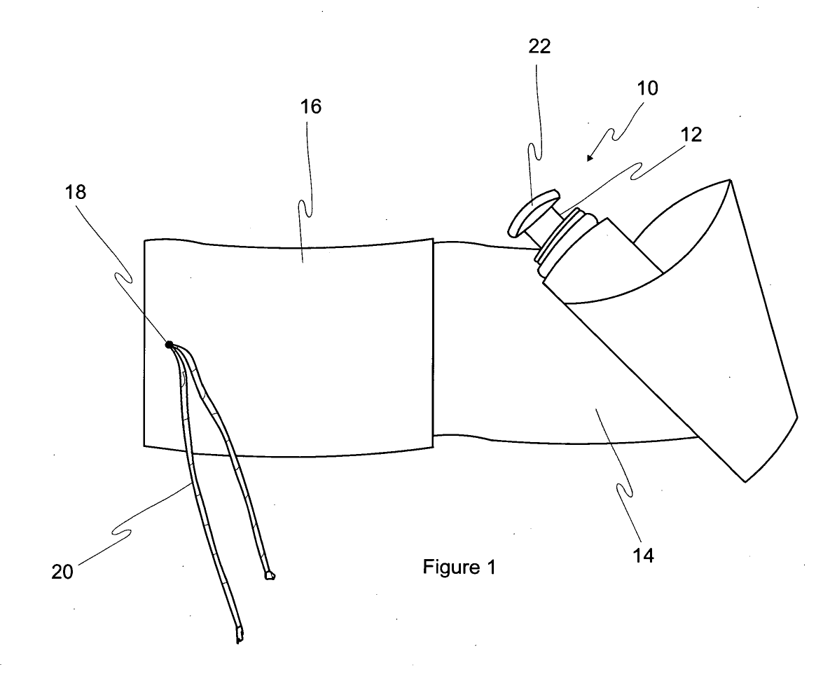

FIG. 1 illustrates a side view of an unwrapped decorative scroll according to one embodiment of the present invention. The decorative scroll 10 includes a frame 12, a writing sheet 14 attached to the frame 12, and a decorative section 16 attached to the writing sheet 14 configured to wrap around the writing sheet 14 when the writing sheet 14 is wrapped around the frame 12 to provide a decorative appearance to the decorative scroll 10. In one embodiment, the decorative section 16 overlays the writing sheet 14. In the illustrated embodiment, the decorative section 16 attaches to an end of the writing sheet 14. The decorative section 16 may be attached to the writing sheet with any well known attaching means, such as glue or tape.

Advantageously, the writing sheet 14 is sufficiently long to allow a user to add large volumes of information, photographs, pictures, text, and drawings. The writing sheet 14 may be any length desired. In one embodiment, the decorative section 16, which is generally a more expensive piece relative to the writing sheet 14, is only long enough to cover the writing sheet 14 when the writing sheet 14 and the decorative section 16 are wrapped around the frame 12. This decreases overall costs of the decorative scrolls 10, but allows greater functionality due to the increased writing sheet 14 length. Accordingly, because the decorative section 16 covers the writing sheet 14, observers only view the decorative section 16. The decorative section 16 also serves to cover personal or private information on the writing sheet 14.

The decorative section 16 includes a hole 18 for receiving a cord 20. The cord 20 is configured to securely hold the scroll in a wrapped position when the writing sheet 14 and the decorative section 16 have been rolled around the frame 12. One skilled in the art will recognize that any type of securing device may be used to hold the decorative scroll in the wrapped position, including, but not limited to snaps, clasps, clips, and buttons.

A handle 22 extends from the frame 12. The handle 22 may be used to assist in rolling the writing sheet 14 and the decorative section 16.

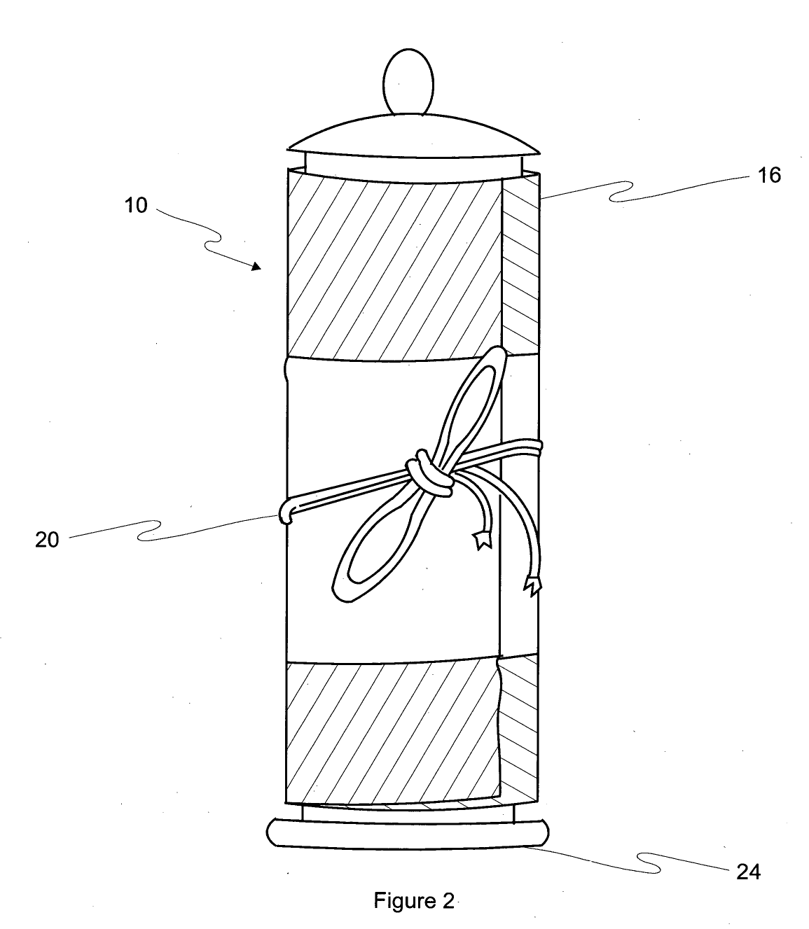

FIG. 2 illustrates a side view of a decorative scroll 10 according to one embodiment of the present invention. The decorative scroll 10 includes a base, or pedestal, 24 to allow the decorative scroll 10 to be placed in a vertical orientation. The base 24 allows the user to place the decorative scroll 10 in almost any flat location, unlike typical scrolls which require the user to lay the scroll down, or attach the scroll to a wall, or other vertical structure.

The decorative scroll 10 is illustrated in a wrapped, or closed position, with the cord 20 holding the decorative section 16 wrapped around the writing sheet 14 (See FIG. 1).

It is envisioned that the decorative scroll 10 may be decorated with many types of decorations, such as fabrics, wings, sporting memorabilia, photographs, drawings, and pictures, or whatever type of design a creator imagines.

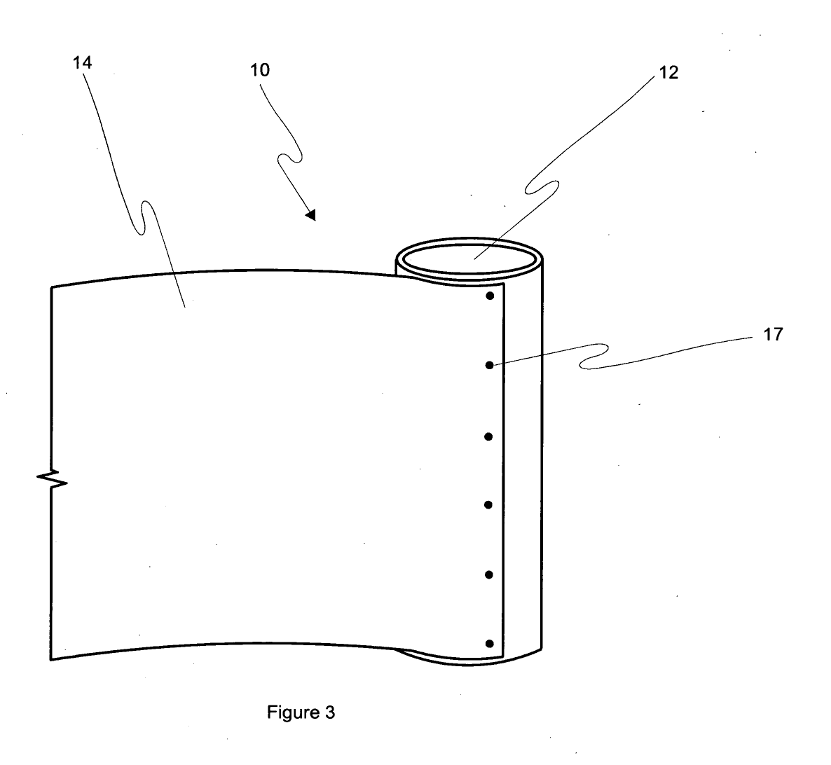

FIG. 3 illustrates a manner in which writing sheets 14 may be attached to the frame 12 of the decorative scroll 10 according to one embodiment of the present invention. As illustrated, the writing sheet 14 attaches to the frame 12 with fasteners 17, such as brads, nails, or screws. It is envisioned, however, that any kind of fastener 17 may be used, including glue or tape.

With the writing sheet 14 attached to the frame 12, the user can roll the writing sheet 14 around the frame 12.

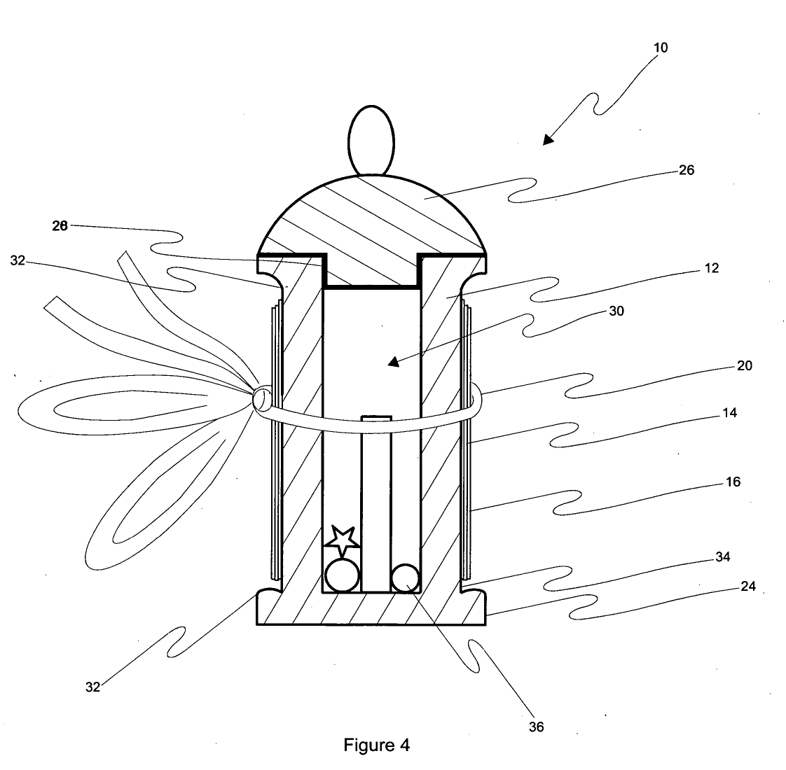

FIG. 4 illustrates a side cross-sectional view of the decorative scroll 10 according to one embodiment of the present invention. In the illustrated embodiment, the decorative scroll 10 includes a removable handle 26 coupled to the frame 12. The removable handle 26 attaches to the frame 12 via a coupling means 28, such as threads, friction, or bayonet fit. One skilled in the art will recognize that there are numerous methods and apparatus for coupling the removable handle 26 to the frame 12.

In one embodiment, the removable handle 26 is also decorated. In a preferred embodiment, the removable handle 26 is decorated to coincide with the purpose of the decorative scroll 10. Particularly, the removable handle 26 may be decorated to appear as a helmet of the owner's favorite football team, or as a baseball cap. The removable handle 26 may be a decorated doorknob, a sword handle, a pistol grip, or any other type of suitable or appropriate design. One skilled in the art will recognize that any design of removable handle 26 is possible.

The removable handle 26 is configured to provide access to a holding area 30 within the frame 12. The holding area 30 may be used to store objects 36, such as photographs and souvenirs that reflect the purpose of the decorative scroll 10. For example, if the decorative scroll 10 is used to indicate the owner's affinity to a particular baseball team, the removable handle 26 may be decorated to appear as the team's baseball cap, and the holding area 30 can be used to store baseball cards of the team's players. In another example, if the decorative scroll 10 was used to record information about a birth of a child, the writing sheets 14 may include a list of all the hospital visitors, gifts received, photographs, etc., and the holding area 30 may be used to store some of the gifts received and baby identification tags.

The frame 12 further includes rails 32 for guiding the writing sheets 14 and the decorative section 16 into a central location along the frame 12. The rails 32 prevent the writing sheets 14 from miswrapping. Additionally, the rails 32 create a recessed section 34 along the length of the frame 12, between the rails 32 to protect both the writing sheets 14 and the decorative section 16 from damage.

The base 24 allows the user to place the decorative scroll 10 in a vertical orientation.

It is understood that the above-described arrangements are only illustrative of the application of the principles of the present invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A decorative scroll comprising:
a frame;
a writing sheet attached to the frame; and
a decorative section attached to the writing sheet configured to wrap around the writing sheet when the writing sheet is wrapped around the frame to provide a decorative appearance thereto.

2. The decorative scroll according to claim 1, wherein the decorative section is a material attached to a back side of the writing sheet configured to hide the writing sheet when the writing sheet and decorative section are wrapped around the housing.

3. The decorative scroll according to claim 1, wherein the decorative section is attached to a distal end of the writing sheet, and exposed on both sides when unwrapped, the decorative section configured to hide the writing sheet when the writing sheet and decorative section are wrapped around the housing.

4. The decorative scroll according to claim 1, further comprising at least one handle attached to the frame.

5. The decorative scroll according to claim 1, wherein the decorative section further comprises a securing apparatus configured to secure the decorative section in a wrapped position about the frame.

6. The decorative scroll according to claim 5, wherein the securing apparatus is a cord.

7. The decorative scroll according to claim 5, wherein the securing apparatus is a button.

8. The decorative scroll according to claim 5, wherein the securing apparatus is a clasp.

9. The decorative scroll according to claim 5, wherein the securing apparatus is a clip.

10. A decorative scroll comprising:
a hollow frame configured to hold items;
a writing sheet attached to the frame; and
a removable handle coupled to the frame.

11. The decorative scroll according to claim 10, wherein the handle is a door knob.

12. The decorative scroll according to claim 10, wherein the handle is a helmet configured to represent a particular sport team.

13. The decorative scroll according to claim 10, wherein the handle screws on.

14. The decorative scroll according to claim 10, wherein the handle friction fits into the hollow frame.

15. The decorative scroll according to claim 10, wherein the handle is a bayonet fit.

16. The decorative scroll according to claim 10, further comprising a decorative section attached to the writing sheet, and configured to wrap around the writing sheet to provide a decorative appearance.

17. A decorative scroll comprising:
a frame;
a handle attached to the frame;
a writing sheet attached to the frame; and
a base attached to the frame, and configured to allow for vertical orientation of the scroll.

18. The decorative scroll according to claim 17, further comprising a decorative section attached to the writing sheet, and configured to wrap around the writing sheet to provide a decorative appearance.

19. The decorative scroll according to claim 18, further comprising a pair of wings attached to the decorative section.

20. The decorative scroll according to claim 18, further comprising rails at distal ends of the frame configured to guide the writing sheet onto the frame as the writing sheet is rolled into a wrapped position on the frame.
